(19) United States
(12) Patent Application Publication
(10) Pub. No.: US 2025/0230295 A1
(43) Pub. Date: Jul. 17, 2025

(54) LOW MELTING GLASS POWDER USED AS ADDITIVE FOR FLAME RETARDANT COMPOSITION

(71) Applicant: CORNING RESEARCH & DEVELOPMENT CORPORATION, Corning, NY (US)

(72) Inventors: Yves Andre Henri Brocheton, Samoreau (FR); Patrick C. Jean, Moret-Loing-et-Orvanne (FR)

(21) Appl. No.: 19/170,652

(22) Filed: Apr. 4, 2025

Related U.S. Application Data
(63) Continuation of application No. PCT/US2023/034269, filed on Oct. 2, 2023.
(60) Provisional application No. 63/414,993, filed on Oct. 11, 2022.

(51) Int. Cl. C08K 3/40; C08K 3/22; C08L 23/0853; G02B 6/44

(52) U.S. Cl. CPC C08K 3/40; C08K 3/22; C08L 23/0853; G02B 6/4436; C08K 2003/2227; C08K 2201/005; C08L 2201/02; C08L 2205/025; C08L 2205/03

(57) ABSTRACT

Embodiments of a flame retardant composition are provided. The flame retardant composition includes 30 wt % to 50 wt % of a polymer component and 50 wt % to 70 wt % of a filler component. The filler component includes a flame retardant powder and a glass powder. A weight ratio of the flame retardant powder to the glass powder is from 1:1 to 11:1. The glass powder is formed from a lead-free phosphate glass having a glass transition temperature of at most 550° C. and a softening point of at most 700° C. The flame retardant composition can be used to form a component of an optical fiber cable.

### CROSS-REFERENCE TO RELATED APPLICATIONS

This application is a Continuation of International Application No. PCT/US2023/034269, filed Oct. 2, 2023, which claims the benefit of priority of U.S. Provisional Application No. 63/414,993 filed on Oct. 11, 2022, the content of which is relied upon and incorporated herein by reference in its entirety.

### BACKGROUND

The disclosure relates generally to flame retardant compositions and more particularly to a glass additive used in a flame retardant composition. Optical fiber cables typically have cable jackets made from a polymeric material. When used in certain applications, it may be desirable to use a flame retardant additive in the polymeric material of the cable jacket. Flame retardant cable jackets may help diminish the effects of a fire or prevent spread when a fire breaks out in a premises. For example, some flame retardants may limit the amount of smoke produced by the fire, and others may limit the ability of the fire to spread along the cable, thereby cutting off one pathway for a fire to spread to multiple rooms of a premises.

### SUMMARY

In one aspect, embodiments of the present disclosure relate to a flame retardant composition. The flame retardant composition includes 30 wt % to 50 wt % of a polymer component and 50 wt % to 70 wt % of a filler component. The filler component includes a flame retardant powder and a glass powder. A weight ratio of the flame retardant powder to the glass powder is from 1:1 to 11:1. The glass powder is formed from a lead-free phosphate glass having a glass transition temperature of at most 550° C. and a softening point of at most 700° C.

In another aspect, embodiments of the present disclosure relate to an optical fiber cable. The optical fiber cable includes a cable jacket having an inner surface and an outer surface. The inner surface defines a central bore extending along a length of the optical fiber cable, and the outer surface defines an outermost surface of the optical fiber cable. A cable core is disposed within the central bore, and the cable core includes at least one optical fiber. The cable jacket is made of a flame retardant composition that includes a polymer component and a filler component. The filler component includes a flame retardant powder and a glass powder. A weight ratio of the flame retardant powder to the glass powder is from 1:1 to 11:1. The glass powder is formed from a lead-free phosphate glass including phosphate (P₂O₅) and at least one of zinc oxide (ZnO), sodium oxide (Na₂O), or potassium oxide (K₂O). The phosphate is present in a highest amount in terms of mole percent (mol %).

In still another aspect, embodiments of the present disclosure relate to a method of forming a component of an optical fiber cable. In the method, a flame retardant composition is compounded. The flame retardant composition includes a polymer component and a filler component. The filler component includes a flame retardant powder and a glass powder. A weight ratio of the flame retardant powder to the glass powder is from 1:1 to 11:1, and the glass powder is formed from a lead-free phosphate glass including phosphate (P₂O₅) and at least one of zinc oxide (ZnO), sodium oxide (Na₂O), or potassium oxide (K₂O). The phosphate is present in a highest amount in terms of mole percent (mol %). Further, in the method, the flame retardant composition is extruded to form the component.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts an optical fiber cable having one or more components comprised at least partially of a flame retardant composition, according to an exemplary embodiment;

FIG. 2 is a flow diagram of the steps of preparing an optical fiber cable having a component formed of the flame retardant composition, according to an exemplary embodiment;

FIG. 3 depicts a graph of heat release rate as a function of time for a control sample and two samples according to the present disclosure;

FIGS. 4A and 4B depict sample plates after having undergone cone calorimetry testing for a control sample and for a first sample according to an embodiment of the present disclosure;

FIGS. 5A and 5B depict side views of sample plates after having undergone cone calorimetry testing for a control sample and for a second sample according to an embodiment of the present disclosure; and

FIG. 6 depicts a detail view of the second sample shown in FIG. 5B, according to an embodiment of the present disclosure.

### DETAILED DESCRIPTION

Referring generally to the following description and appended figures, various embodiments of a flame retardant composition including a lead-free phosphate glass powder filler, an optical fiber cable including a component formed from the flame retardant composition, and a method of forming the component are provided. The flame retardant composition includes a lead-free phosphate glass powder filler that helps the composition to form an intumescent barrier during combustion, thereby decreasing the peak heat release rate during combustion, slowing down the rate of combustion, and limiting flame spread. In particular, the inventors believe that the glass powder filler acts as a glue to form and strengthen a char layer during combustion. As will be described more fully below, the lead-free phosphate glasses used to form the powder filler described herein have a softening temperature sufficiently low to melt or soften during combustion such that the lead-free phosphate glasses decompose to form char strengtheners or to release gases that provide an intumescent effect. These and other aspects and advantages of the disclosed flame retardant composition, optical fiber cable, and method of forming the same will be described herein and in relation to the figures. Such exemplary embodiments are provided by way of illustration and not by way of limitation.

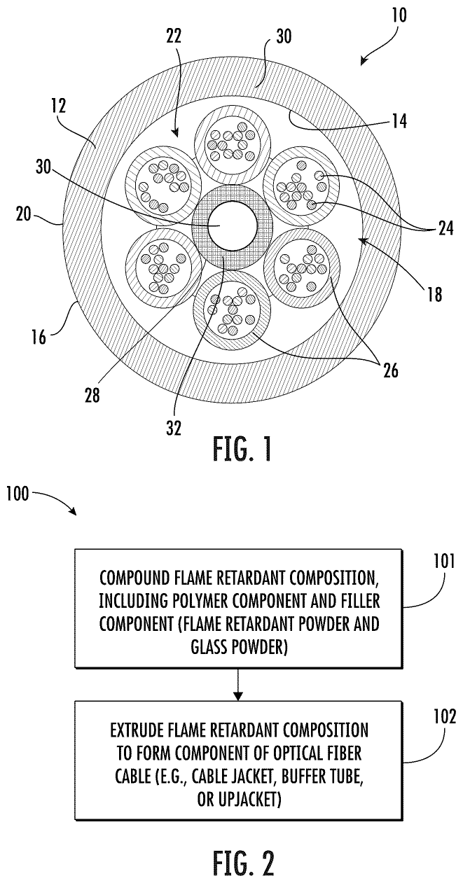

FIG. 1 depicts an exemplary embodiment of an optical fiber cable 10. The optical fiber cable 10 includes a cable jacket 12. The cable jacket 12 includes an inner surface 14 and an outer surface 16. The inner surface 14 defines a central bore 18 of the optical fiber cable 10 that extends along a length of the optical fiber cable 10. In one or more embodiments, the outer surface 16 of the cable jacket 12 is an outermost surface of the optical fiber cable 10.

Disposed within the central bore 18 is a cable core 22. The cable core 22 includes all of the elements within the cable jacket 12 including at least one optical fiber 24. In the embodiment depicted, the optical fibers 24 are contained in buffer tubes 26 stranded around a central strength member 28. In one or more embodiments, the central strength member 28 includes a tensile element 30 and an upjacket 32 formed around the tensile element 30. In the embodiment depicted in FIG. 1, six buffer tubes 26 are stranded around and contact the central strength member 28, in particular contacting the upjacket 32. Each buffer tube 26 in the embodiment depicted contains twelve optical fibers 24 in a loose tube configuration. The embodiment of the optical fiber cable 10 is merely illustrative, and other optical fiber cable constructions are considered to be within the scope of the present disclosure.

In one or more embodiments, the cable core 22 can include anywhere from one to several hundred or even thousands of optical fibers 24. Further, the optical fibers 24 may be in a loose tube or a ribbon configuration within the buffer tubes 26. Additionally, the optical fibers 24 may not be arranged in buffer tubes 26 and may instead be loose within the cable jacket 12 or arranged in ribbons within the cable jacket 12. Still further, the optical fibers 24 may be divided into other subunit structures, such as grouped within binding films or thin membranes. In one or more embodiments, the cable core 22 includes one or more other structures, such as an armor layer; a water-blocking tape, powder, or yarn; strengthening yarns; a binder wrap or film; and a ripcord, among other possibilities.

According to embodiments of the present disclosure, the optical fiber cable 10 includes one or more components, such as the cable jacket 12, the buffer tubes 26, or the upjacket 32, comprised of a flame retardant composition including a polymer component and a filler component dispersed in the polymer component. The filler component includes a flame retardant powder and a glass powder. In one or more embodiments, the flame retardant powder comprises mineral fillers, such as one or more of alumina trihydrate (ATH), magnesium dihydroxide (MDH), boehmite, huntite, and hydromagnesite. In one or more embodiments, the flame retardant powder has a median particle size (d50) of 50 μm or less, in particular 10 μm or less, and most particularly 5 μm or less. In one or more embodiments, the flame retardant power has a median particle size (d50) of at least 0.1 μm.

In one or more embodiments, the glass powder is a lead-free phosphate glass powder. In one or more such embodiments, the lead-free phosphate glass powder is at least one of a sodium zinc phosphate glass powder, a potassium phosphate glass powder, or a sodium phosphate glass powder. In one or more embodiments, the lead-free phosphate glass includes phosphate (P₂O₅) and at least one of zinc oxide (ZnO), sodium oxide (Na₂O), or potassium oxide (K₂O) with phosphate being the highest constituent of the lead-free phosphate glass in terms of mole percent (mol %).

In one or more embodiments of the sodium zinc phosphate glass powder, the largest constituent in terms of mole percent (mol %) is phosphate (P₂O₅). In one or more embodiments, the second largest constituent in terms of mole percent is zinc oxide (ZnO), i.e., P₂O₅>ZnO. In one or more embodiments, the third largest constituent in terms of mole percent is sodium oxide (Na₂O), i.e., P₂O₅>ZnO>Na₂O. In one or more embodiments, the sodium zinc phosphate glass powder may comprise further constituents, such as lithium oxide (Li₂O) and potassium oxide (K₂O), in an amount such that each further constituent is less than P₂O₅, ZnO, and K₂O, i.e., P₂O₅>ZnO>Na₂O>Li₂O, K₂O.

In one or more embodiments of the potassium phosphate glass powder, the largest constituent in terms of mole percent (mol %) is P₂O₅, and the second largest constituent in terms of mole percent is K₂O.

In one or more embodiments of the sodium phosphate glass powder, the largest constituent in terms of mole percent (mol %) is P₂O₅, and the second largest constituent in terms of mole percent is Na₂O.

In one or more embodiments, the lead-free phosphate glass comprises from 30 mol % to 70 mol % P₂O₅, in particular 40 mol % to 65 mol % P₂O₅. In one or more embodiments, the lead-free phosphate glass comprises from 20 mol % to 40 mol % ZnO, in particular 25 mol % to 35 mol % ZnO. In one or more embodiments, the lead-free phosphate glass comprises from 5 mol % to 35 mol % Na₂O, in particular 8 mol % to 15 mol % Na₂O. In one or more embodiments, the lead-free phosphate glass comprises from 20 mol % to 40 mol % of alkali metal oxides (R₂O in which R₂O=Na₂O+Li₂O+K₂O), in particular from 25 mol % to 35 mol % of R₂O. In one or more particular embodiments, R₂O comprises from 1 mol % to 15 mol % Li₂O, in particular 5 mol % to 11 mol % Li₂O, and/or from 3 mol % to 35 mol % K₂O, in particular from 5 mol % to 20 mol % K₂O. In one or more embodiments, the lead-free phosphate glass is substantially free of lead (PbO), e.g., 0.01 mol % or less present, which is present only (if at all) as an impurity.

Advantageously, a lead-free phosphate glass as described is non-toxic during combustion. Further, such a lead-free phosphate glass can be prepared using existing melting techniques, in particular exhibiting compatibility with commonly used platinum or platinum alloy tools. Still further, the lead-free phosphate glass can be formed into frit by pouring the molten glass into water to obtain frit, which can be milled down to obtain the lead-free phosphate glass powder. Additionally, the lead-free phosphate glass has a glass transition temperature (T_{g}) and a softening temperature (T₁) low enough such that the glass melts or softens at polymer processing and combustion temperatures.

In one or more embodiments, the lead-free phosphate glass consists essentially of P₂O₅, ZnO, Na₂O, Li₂O, and K₂O. In one or more embodiments, the lead-free phosphate glass contains no other constituents (besides P₂O₅, ZnO, Na₂O, Li₂O, and K₂O) at more than 2 mol %, in particular at no more than 1 mol %, and most particularly at no more than 0.5 mol %. In one or more embodiments, the lead-free phosphate glass consists essentially of P₂O₅ and K₂O, and the lead-free phosphate glass contains no other constituents (besides P₂O₅ and K₂O) at more than 2 mol %, in particular at no more than 1 mol %, and most particularly at no more than 0.5 mol %. In one or more embodiments, the lead-free phosphate glass consists essentially of P₂O₅ and Na₂O, and the lead-free phosphate glass contains no other constituents (besides P₂O₅ and Na₂O) at more than 2 mol %, in particular at no more than 1 mol %, and most particularly at no more than 0.5 mol %. Constituents that would materially affect the basis and novel characteristics of the lead-free glass are those that would substantially increase the glass transition temperature or softening point of the glass, that would render the glass toxic (e.g., Pb, As, or Cd), or that would cause the glass to devitrify.

In one or more other embodiments, the lead-free phosphate glass may comprise one or more other constituents including Al₂O₃, ZrO₂, B₂O₃, SO₃, and alkaline earth oxides (RO in which RO=MgO+CaO+SrO+BaO). In one or more such embodiments, the lead-free phosphate glass may contain up to 5 mol % Al₂O₃, in particular up to 2 mol % Al₂O₃. In one or more such embodiments, the lead-free phosphate glass may contain up to 5 mol % ZrO₂, in particular up to 2 mol % ZrO₂. In one or more such embodiments, the lead-free phosphate glass may contain up to 10 mol % B₂O₃, in particular up to 5 mol % B₂O₃. In one or more such embodiments, the lead-free phosphate glass may contain up to 5 mol % SO₃, in particular up to 3 mol % SO₃. In one or more such embodiments, the lead-free phosphate glass may contain up to 20 mol % RO, in particular up to 10 mol % RO. That is, the lead-free phosphate glass may contain up to 20 mol %, in particular up to 10 mol %, of one of or a combination of two or more of MgO, CaO, SrO, and BaO.

In one or more embodiments, the lead-free phosphate glass may contain other minor constituents, such as up to a total of 5 mol %, in particular up to a total of 2 mol %, of transition metals (Ti, Cr, Fe, Ni, Cu, Ag, and Pt) and/or up to 5 mol %, in particular up to 3 mol %, of one of or a combination of two or more of Sb₂O₃, Bi₂O₃, V₂O₅, and MoO₃.

In one or more embodiments, the lead-free phosphate glass has a softening point T₁ of 700° C. or less, in particular 600° C. or less, and more particularly 500° C. or less. In one or more embodiments, the lead-free phosphate glass has a softening point T₁ of 200° C. or more. In one or more embodiments the lead-free phosphate glass has a glass transition temperature T_{g} of 550° C. or less, in particular 400° C. or less, and more particularly 300° C. or less. In one or more embodiment, the lead-free phosphate glass has a glass transition temperature T_{g} of 90° C. or more, in particular 100° C. or more, and most particularly 150° C. or more.

In one or more embodiments, the lead-free phosphate glass is non-hydroscopic or minimally hydroscopic. In one or more embodiments, the lead-free phosphate glass increases in mass by less than 2% as compared to the dry mass when tested for hygroscopicity according to ASTM D5229/D5229M-20.

In one or more embodiments, the lead-free phosphate glass is milled, ground, or otherwise attrited to a median particle size (d50) that is 50 μm or less, in particular 10 μm or less, and most particularly 5 μm or less.

In one or more embodiments, a ratio of the flame retardant powder to the glass powder in the filler component of the flame retardant composition is from 1:1 to 11:1, in particular from 2:1 to 5:1.

In one or more embodiments, the polymer component of the flame retardant composition includes one or more thermoplastic polymers, elastomers, thermoplastic elastomers, or a combination thereof. Exemplary polymers include ethylene-vinyl acetate copolymers, ethylene-acrylate copolymers, polyethylene homopolymers (low, medium, and high density), linear low density polyethylene, very low density polyethylene, polypropylene homopolymer, polyolefin elastomer copolymer, polyethylene-polypropylene copolymer, butene- and octane-branched copolymers, or maleic anhydride-grafted versions of the foregoing polymers. Other polymers are possible for use in the polymer component of the flame retardant composition, and the foregoing list is merely illustrative. In one or more embodiments, the polymer component also includes a methacrylic acid grafted, a silane, or a peroxide coupling agent.

In one or more embodiments, the polymer component comprises a blend of ethylene vinyl acetate (EVA) and linear low density polyethylene (LLDPE). In one or more embodiments, the polymer component may further comprise a coupling agent, such as methacrylic acid grafted LLDPE (MAA-g-LLDPE). In one or more particular embodiments, the polymer component comprises a weight ratio of EVA to LLDPE in a range from 2:1 to 4:1. Further, in one or more embodiments, the polymer component comprises a weight ratio of LLDPE to MAA-g-LLDPE in a range from 1:1 to 2:1.

In one or more embodiments, the flame retardant composition comprises from 30 wt % to 50 wt % of the polymer component and from 50 wt % to 70 wt % of the filler component, which is dispersed in the polymer component. In one or more embodiments, the flame retardant composition may consist essentially of the polymer component and the filler component. In such embodiments, the flame retardant composition may also include colorants, processing aids, and other performance additives without materially affecting the basic and novel characteristics of the flame retardant composition.

Having described an embodiment of the optical fiber cable 10 and a flame retardant composition for components thereof (such as the cable jacket 12, buffer tubes 26, or upjacket 32), an embodiment of a method 100 of preparing the flame retardant composition and extruding it as a component of an optical fiber cable 10 is now described in relation to the embodiment depicted in FIG. 1 and the flow diagram of FIG. 2. In one or more embodiments, the method 100 involves a first step 101 of compounding the flame retardant composition by mixing the polymer component and the filler component, including the flame retardant powder and the glass powder, to disperse the filler component in the polymer component.

After the first step 101, the flame retardant composition is extruded to form the component of the optical fiber cable 10 in a second step 102. For example, if the component is an upjacket 32, the flame retardant composition is extruded around a tensile element 30 to form the central strength member 28. In another example, if the component is a buffer tube 26, then the flame retardant composition is extruded around at least one optical fiber 24. In still another example, if the component is a cable jacket 12, then the flame retardant composition is extruded around a cable core 22 that includes at least one optical fiber 24. In one or more embodiments, the optical fiber cable 10 includes multiple components comprised of the flame retardant composition, such as at least two of the cable jacker 12, the buffer tubes 26, or the upjacket 32.

### Experimental Embodiment

Glass powders having the compositions described in Table 1 were prepared.

TABLE 1
Glass Powder Compositions and Properties

| | Composition 1 | | Composition 2 | Composition 3 |
|---|---|---|---|---|
| | Mol % | Wt % | Mol % | Mol % |
| P₂O₅ | 40 | 57.5 | 65 | 65 |
| Li₂O | 10.6 | 3.2 | | |
| Na₂O | 12 | 7.55 | | 35 |
| K₂O | 7.5 | 7.1 | 35 | |
| ZnO | 29.9 | 24.65 | | |

Physical Properties

| | | | | |
|---|---|---|---|---|
| R₂O (mol %) | 30.1 | 17.85 | 35 | 35 |

| | | | |
|---|---|---|---|
| T_{g} (° C.) | 278 | 167 | 95 |
| T₁ (° C.) | 339 | 203 | Not |

determined

From Table 1, it can be seen that the glass compositions are lead-free phosphate glasses. For Composition 1, the glass transition temperature (T_{g}) is 278° C., and the softening point (T₁) is 339° C. For Composition 2, the glass transition temperature (T_{g}) is 167° C., and the softening point (T₁) is 203° C. For Composition 3, the glass transition temperature (T_{g}) dropped to 95° C.

The lead-free phosphate glass of Composition 1 was attrited to a median particle size (d50) of 1.5 μm to 2.5 μm. This glass powder was combined with a flame retardant powder, in particular ATH, to form the filler component of the flame retardant composition. The ATH was commercially obtained (Martinal® OL-104 LEO available from Martinswerk GmbH, Bergheim, Germany) and had a median particle size (d50) of 1.8 μm to 2.1 μm.

The filler component was combined with the polymer component to form the flame retardant composition. The polymer component comprised 67 wt % of EVA (24 wt % vinyl acetate), 21 wt % of LLDPE, and 12 wt % of MAA-g-LLDPE. In particular, each sample prepared included 40 wt % of the polymer component and 60 wt % of the filler component with varying weight ratios of flame retardant powder to glass powder. A control sample (Control) was prepared in which the filler component included only ATH (i.e., 60 wt % of ATH). A first experimental sample (Sample 1) was prepared comprising a weight ratio of 5:1 ATH to lead-free phosphate glass (LPG) powder (i.e., 50 wt % ATH and 10 wt % LPG), and a second experimental sample (Sample 2) was prepared comprising a weight ratio of 2:1 ATH to LPG powder (i.e., 40 wt % ATH and 20 wt % LPG).

The samples (Control, Sample 1, and Sample 2) were formed into plates having the dimensions of 100 mm×100 mm×3 mm for cone calorimeter testing. During cone calorimeter testing, the properties of the samples are evaluated related to ignition and flaming combustion performance. In particular, the ignition parameter measured in the cone calorimeter is the time to ignition (TTI), which depends on the thermal inertia, critical heat flux, and critical mass loss for ignition, or alternatively the critical surface temperature for ignition. Fire response parameters measured in the cone calorimeter include mass loss, heat release rate (HRR), total heat release (THR), smoke production, and CO production.

Cone calorimeter tests (according to ISO 5660) are used to compare the fire response of materials and assess their fire performance. The plates of the samples were exposed to a constant heat flux generated by a radiant cone, and ignition was forced by a spark igniter positioned 1 cm over the plate. Time to ignition (TTI) was determined by visual check. The combustion products are collected by a hood and evacuated through a duct where the gas is sampled to measure O₂, CO₂, and CO concentrations. The heat release rate (HRR) is then determined by oxygen consumption according to the Huggett principle that states that 13.1 kJ of energy is released when 1 g of oxygen is consumed. Integrating HRR over the test time enables the determination of the total heat release (THR). The sample holder was placed on a balance, and the mass loss rate (MLR) was measured throughout the test. Integrating MLR enables the determination of the mass loss (ML). The smoke production rate (SPR) is also determined through the attenuation of a laser beam that crosses an evacuation duct.

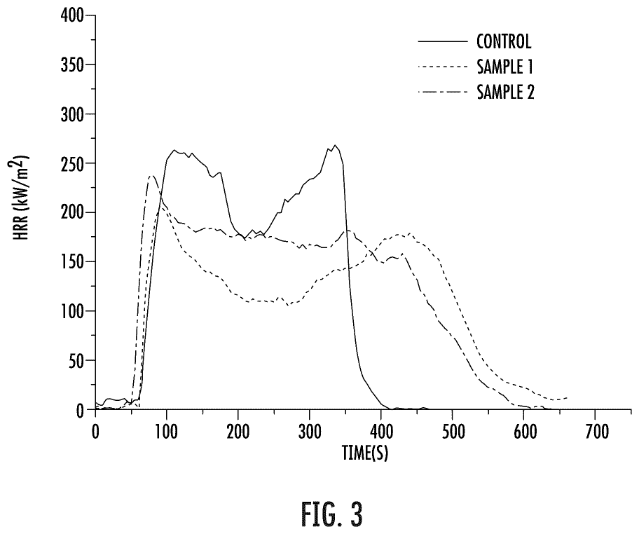

FIG. 3 depicts graphs of HRR as a function of time for Control, Sample 1, and Sample 2. Table 2 provides a summary of various parameters that can be determined from the graphs shown in FIG. 3. From FIG. 3 and Table 2, it can be seen that the samples including the glass powder exhibited flatter, more spread out HRR curves with lower peak heat release rates (PHHR). In particular, FIG. 3 shows that each sample had similar TTI of around 60 seconds. Control had the highest first PHRR (PHRR1) of 264 kW/m² at 135 seconds. Sample 1 and Sample 2 had lower PHRR1 of 208 kW/m² and 231 kW/m² at 90 seconds and 80 seconds, respectively. Thus, PHRR1 for the samples according to the present disclosure was lower than PHRR1 of the control sample but occurred at a sooner time.

TABLE 2
Cone Calorimeter Test Results

| | | PHRR1 | Time at | PHRR2 | Time at | THR |
|---|---|---|---|---|---|---|
| | TTI | (kW/ | PHHR1 | (kW/ | PHRR2 | (MJ/ |
| Sample | (s) | m²) | (s) | m²) | (s) | m²) |
| Control | 59 | 264 | 135 | 269 | 335 | 64.5 |
| Sample 1 | 63 | 208 | 90 | 179 | 440 | 68.9 |
| Sample 2 | 56 | 231 | 80 | 189 | 395 | 76.6 |

Further, FIG. 3 shows that each sample had a second PHRR (PHRR2). Control had a PHRR2 of 269 kW/m² at 335 seconds, and Sample 1 and Sample 2 had PHRR2 of 179 kW/m² and 189 kW/m² at 440 seconds and 395 seconds, respectively. The PHRR2 for the samples according to the present disclosure remained lower than the PHRR2 of the control sample and occurred at a later time. As shown in Table 2, the control sample had a total heat release of 64.5 MJ/m², and Sample 1 and Sample 2 had total heat releases of 68.9 MJ/m² and 76.6 MJ/m², respectively. Thus, while Sample 1 and Sample 2 had higher total heat release, the heat released is less intense (lower PHRR) and takes place over a longer time.

From FIG. 3 and Table 2, it can be seen that at least partial substitution of conventional ATH with glass powder improves fire performance of the flame retardant composition. The glass powder did not substantially affect time to ignition (TTI), but it does reduce PHRR1 and PHRR2, decreases of the mean value of HRR during combustion, and increases time to PHRR2 and the burning time (time-to-flame out). In one or more embodiments, the substitution of ATH with glass powder does not exceed below a weight ratio of 1:1, in particular below a weight ratio of 2:1, because of the removal of water as the decomposition product of ATH during combustion.

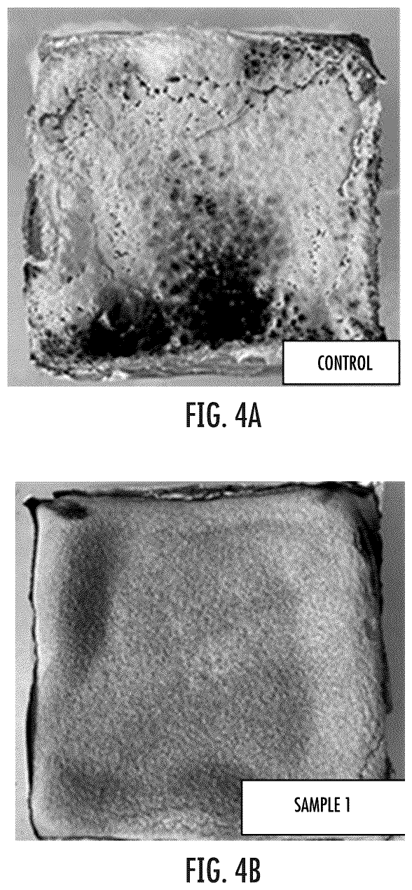

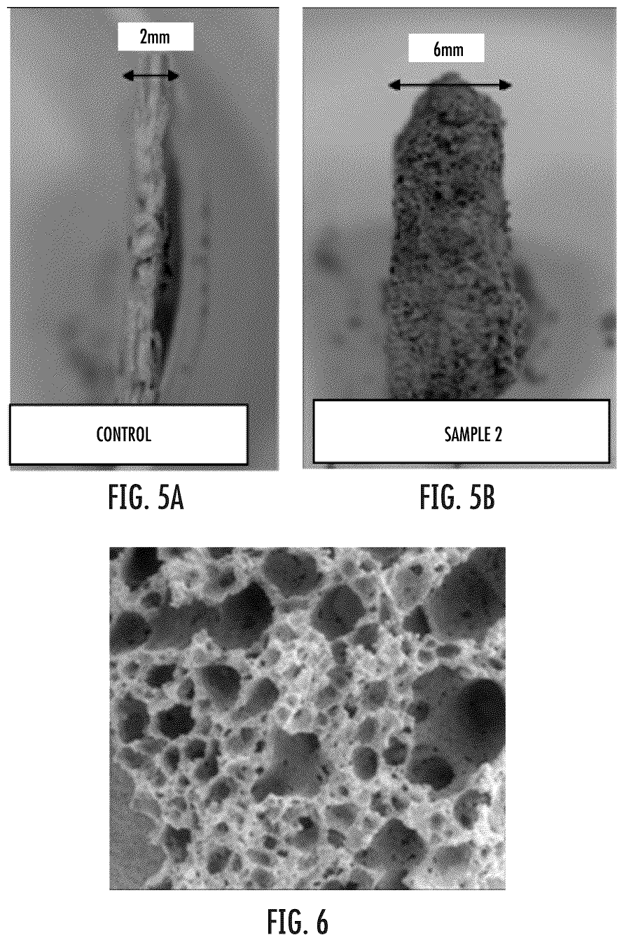

FIGS. 4A and 4B depict the residues of sample plates of Control and Sample 1, respectively, after combustion. Comparing FIGS. 4A and 4B, it can be seen that Sample 1 has a smoother appearance, resulting from the stronger char layer provided by the addition of the glass powder. Further, FIGS. 5A and 5B demonstrate that the addition of glass powder also resulted in an expanded char structure. FIG. 5A depicts a side view of the Control sample plate after combustion, and FIG. 5B depicts a side view of the Sample 2 plate after combustion. As mentioned above, the original thickness of each plate was 3 mm. After combustion, the Control sample plate reduced in thickness to 2 mm or less, whereas the Sample 2 plate increased in thickness, including up to 6 mm in places. Thus, the addition of the glass powder created an intumescent system for the flame retardant composition. Without wishing to be bound by theory, the inventors surmise that the water vapor produced by ATH swelled the flame retardant composition and the glass powder had a gluing effect, stabilizing the expanded structure.

FIG. 6 depicts a detail view of the expanded structure produced during combustion of Sample 2. The expanded structure creates a thick, non-flammable multicellular barrier that protects the interior material from the action of heat and/or flame.

Thus, the flame retardant composition including the lead-free phosphate glass disclosed herein provides improved flame retardant performance by forming and strengthening the char layer and decreasing the peak heat release rate, in particular to 250 kW/m² or lower (as measured using cone calorimeter). Advantageously, the lead-free phosphate glass can be prepared from readily available, non-toxic, and cost-effective materials.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A flame retardant composition, comprising:
30 wt % to 50 wt % of a polymer component;
50 wt % to 70 wt % of a filler component, the filler component comprising a flame retardant powder and a glass powder;
wherein a weight ratio of the flame retardant powder to the glass powder is from 1:1 to 11:1; and
wherein the glass powder is formed from a lead-free phosphate glass having a glass transition temperature of at most 550° C. and a softening point of at most 700° C.

2. The flame retardant composition of claim 1, wherein the flame retardant powder comprises at least one of aluminum trihydrate, magnesium dihydroxide, boehmite, huntite, or hydromagnesite.

3. The flame retardant composition of claim 1, wherein the lead-free phosphate glass comprises P₂O₅, ZnO, and Na₂O.

4. The flame retardant composition of claim 3, wherein, in terms of mole percent, P₂O₅>ZnO>Na₂O.

5. The flame retardant composition of claim 4, comprising from 30 mol % to 70 mol % P₂O₅, from 20 mol % to 40 mol % ZnO, and from 5 mol % to 35 mol % Na₂O.

6. The flame retardant composition of claim 3, further comprising at least one of Li₂O or K₂O.

7. The flame retardant composition of claim 6, wherein Na₂O+Li₂O+K₂O is from 20 mol % to 40 mol %.

8. The flame retardant composition of claim 1, wherein the lead-free phosphate glass consists essentially of P₂O₅ and K₂O.

9. The flame retardant composition of claim 1, wherein the lead-free phosphate glass consists essentially of P₂O₅ and Na₂O.

10. The flame retardant composition of claim 1, wherein the glass powder comprises a median particle size of 50 μm or less.

11. The flame retardant composition of claim 1, wherein the weight ratio of the flame retardant powder to the glass powder is from 2:1 to 5:1.

12. The flame retardant composition of claim 1, wherein the polymer component comprises a blend of ethylene-vinyl acetate (EVA) and linear low density polyethylene (LLDPE).

13. The flame retardant composition of claim 12, wherein the polymer component further comprises methacrylic acid grafted LLDPE (MAA-g-LLDPE).

14. The flame retardant composition of claim 1, wherein the flame retardant composition is characterized by a peak heat release rate of 250 kW/m² or less as measured using cone calorimeter testing.

15. An optical fiber cable, comprising:
a cable jacket comprising an inner surface and an outer surface, the inner surface defining a central bore extending along a length of the optical fiber cable and the outer surface defining an outermost surface of the optical fiber cable;
a cable core disposed within the central bore, the cable core comprising at least one optical fiber;
wherein the cable jacket comprises a flame retardant composition, comprising:
a polymer component; and
a filler component, the filler component comprising a flame retardant powder and a glass powder;
wherein a weight ratio of the flame retardant powder to the glass powder is from 1:1 to 11:1; and
wherein the glass powder is formed from a lead-free phosphate glass comprising phosphate (P₂O₅) and at least one of zinc oxide (ZnO), sodium oxide (Na₂O), or potassium oxide (K₂O), the phosphate being present in a highest amount in terms of mole percent (mol %).

16. The optical fiber cable of claim 15, wherein the cable core comprises at least one buffer tube, the at least optical fiber being disposed in the at least one buffer tube, and wherein the at least one buffer tube is comprised of the flame retardant composition.

17. The optical fiber cable of claim 16, wherein the at least one buffer tube is stranded around a central strength member, the central strength member comprising a tensile element surrounded by an upjacket, and wherein the upjacket is comprised of the flame retardant composition.

18. The optical fiber cable of claim 15, wherein the flame retardant composition comprises from 30 mol % to 70 mol % of P₂O₅, 20 mol % to 40 mol % of ZnO, and 5 mol % to 35 mol % of Na₂O.

19. The optical fiber cable of claim 15, wherein the lead-free phosphate glass consists essentially of P₂O₅ and Na₂O.

20. The optical fiber cable of claim 15, wherein the lead-free phosphate glass consists essentially of P₂O₅ and K₂O.
